(19) United States
(12) Patent Application Publication
(10) Pub. No.: US 2025/0148622 A1
(43) Pub. Date: May 8, 2025

(54) FAST SCENE FLOW ESTIMATION WITHOUT SUPERVISION

(71) Applicant: isee, Cambridge, MA (US)

(72) Inventors: Rahul Ahuja, Jersey City, NJ (US); Wilko Schwarting, Cambridge, MA (US); Chris L. Baker, Pittsburgh, PA (US)

(21) Appl. No.: 18/938,781

(22) Filed: Nov. 6, 2024

Related U.S. Application Data
(60) Provisional application No. 63/596,868, filed on Nov. 7, 2023.

(51) Int. Cl. G06T 7/246; G01S 17/58; G01S 17/89

(52) U.S. Cl. CPC G06T 7/248; G01S 17/58; G01S 17/89; G06T 2207/10028; G06T 2207/30252

(57) ABSTRACT

The present disclosure relates to a system for estimating flow-vectors, the system including: a sensor configured to generate one or more point-clouds; a controller configured to: receive at least a first point-cloud and a second point-cloud of the one or more point-cloud, based on the first point-cloud and the second point-cloud, determine one or more flow vectors corresponding to points of the first point-cloud and points of the second point-cloud.

### CROSS-REFERENCE TO RELATED APPLICATIONS

This application claims priority, under 35 U.S.C. § 119 (e), to U.S. Provisional Application No. 63/596,868, titled FAST SCENE FLOW ESTIMATION WITHOUT SUPERVISION, filed on Nov. 7, 2023, and hereby incorporated by reference in its entirety for all purposes.

### BACKGROUND

### 1. Field of the Disclosure

At least one example in accordance with the present disclosure relates generally to scene flow estimation.

### 2. Discussion of Related Art

In autonomous driving and robotics, estimating motion of objects may involve determining the likely movement of an object over an interval of time and comparing the estimate to an observation of the actual motion of the object over the interval of time.

### SUMMARY

According to at least one aspect of the present disclosure, a system for estimating flow-vectors is provided, the system comprising: a sensor configured to generate one or more point-clouds; and a controller configured to: receive at least a first point-cloud and a second point-cloud of the one or more point-cloud, and based on the first point-cloud and the second point-cloud, determine one or more flow vectors corresponding to points of the first point-cloud and points of the second point-cloud.

In some examples, the system further comprises a vehicle coupled to the sensor and configured to autonomously navigate a multi-dimensional space. In some examples, determining the one or more flow vectors includes: compensating for motion of the sensor between a first time and a second time, wherein the first time corresponds to when the sensor generates the first point-cloud, and the second time corresponding to when the sensor generates the second point-cloud. In some examples, determining the one or more flow vectors includes: determining one or more nearest neighbor points in the second point-cloud for a point in the first point-cloud; determining a similarity between each of the one or more nearest neighbor points and the point; determining a weight based on the similarity and a predetermined value; and determining a correspondence value based on the weight and a nearest neighbor point to the point. In some examples, the one or more flow vectors includes: for each point in the first point-cloud, determining a respective set of one or more nearest neighbor points in the second point-cloud; for each point in the first point-cloud, determining one or more similarities to each of the one or more nearest neighbor points in the respective set; for each point in the first point-cloud, determining one or more weights based on the one or more similarities; and for each point in the first point-cloud, determining a correspondence value based on the one or more weights and a nearest neighbor point of the respective set. In some examples, determining the one or more flow vectors includes: determining one or more nearest neighbor points in the second point-cloud to a point in the first point-cloud; determining one or more weights corresponding to the one or more nearest neighbor points; and adjusting at least one of the one or more weights based on a threshold distance. In some examples, adjusting at least one of the one or more weights includes: adjusting the at least one of the one or more weights responsive to determining that a nearest neighbor point corresponding to the at least one of the one or more weights is more than the threshold distance from the point in the first point-cloud; and setting the at least one of the one or more weights to zero. In some examples, the threshold distance is adjusted to be greater or less than a current value of the threshold distance based on a maximum threshold distance, a minimum threshold distance, and a number of iterations of determining the one or more flow vectors. In some examples, determining the one or more flow vectors includes: associating one or more points in the first point-cloud with one another based on a proximity of the one or more points in the first point-cloud to one another; and associating one or more points in the second point-cloud with one another based on a proximity of the one or more points in the second point-cloud to one another. In some examples, the sensor is a LIDAR system. In some examples, the controller is further configured to iteratively refine the one or more flow vectors based on a first set of flow vector values and a second set of flow vector values, wherein the second set of flow vector values is based at least in part on the first set of flow vector values.

According to at least one aspect of the present disclosure, a method for estimating flow-vectors is provided, the method comprising: sensing one or more point-clouds; receiving at least a first point-cloud and a second point-cloud of the one or more point-cloud; and based on the first point-cloud and the second point-cloud, determining one or more flow vectors corresponding to points of the first point-cloud and points of the second point-cloud.

According to at least one aspect of the present disclosure, a system for estimating flow-vectors is provided, the system comprising: a sensor configured to generate a plurality of point-clouds; a controller configured to: receive at least a first point-cloud and a second point-cloud of the plurality of point-clouds, based on the first point-cloud and the second point-cloud, determine one or more flow vectors corresponding to points of the first point-cloud and points of the second point-cloud, wherein the flow vectors are determined by optimization of an objective function that considers at least one of: (a) point correspondence matching accomplished by incorporation of a local correlation weight matrix for one of the first and second point cloud sin the objective function, (b) a transformation matrix applied to one of the first or second point clouds that compensates for motion of the sensor with respect to a frame of reference, and (c) an adaptive maximum correspondence threshold for finding neighboring points to a selected first point in one of the first or second point clouds.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates a pair of point-clouds according to an example;

FIG. 1B illustrates a pair of point-clouds with flow vectors according to an example;

FIG. 2 illustrates an ego vehicle system according to an example;

FIG. 3 illustrates an optimization process for estimating flow vectors according to an example;

FIG. 4 illustrates a process for determining a weight matrix according to an example;

FIG. 5 illustrates a process for determining a threshold distance according to an example;

FIG. 6 illustrates a process for optimizing the estimation of flow-vectors according to an example; and

FIG. 7 illustrates a process for optimizing the estimation of flow-vectors according to an example.

### DETAILED DESCRIPTION

In 3-dimensional (3D) motion applications, such as autonomous driving and/or 3D robotics, estimating the motion of objects through space plays a vital role by enabling machines to perceive and navigate through the environment.

Traditional methods of monitoring a scene (the scene being the environment around a sensor configured to monitor that scene) may be supervised or unsupervised. In a supervised approach, scene monitoring is facilitated using a learning algorithm (e.g., a machine learning algorithm or model) trained on annotated data sets. Annotated data sets contain information about the “true” state of the scene, and thus can be used to inform the learning algorithm of when the learning algorithm's estimation of the motion of an object in the scene has deviated from the true state of the scene. This is a form of feedback-loop where the learning algorithm may use the error (e.g., the deviation between estimated state of the scene and true state of the scene) to adjust the weight assigned to various values and/or nodes in the learning algorithm, thereby reducing the error in the future. However, annotated data sets can be difficult to acquire, expensive to purchase and/or produce, and may lack the necessary information (e.g., ground truth flow vectors) to allow for efficient or useful supervised learning. Likewise, learning approaches may be computationally intensive, slow, and require substantial time to execute.

In contrast to supervised methods, unsupervised approaches generally use unsupervised data to train (for example, non-annotated data for which the true state of the scene is unknown). For example, an unsupervised algorithm may use a sequence of stereo images to calculate the 2-dimensional (2D) optical flow between each pair of sequential images by calculating the motion of pixels in the image plane. The application of geometric principles to this comparison may then be used to infer, after the fact, the 3D motion present in the scene captured by the images. However, traditional unsupervised approaches may be computationally intensive, slow, and may be difficult to execute in practice (e.g., when actually trying to navigate an autonomous vehicle through a physical space).

Aspects and elements of this disclosure relate to fast, non-learning optimization-based methods and systems for determining the 3D movement of objects in a scene. In particular, aspects of this disclosure address using point-cloud data, such as that returned by a light detection and ranging system (LIDAR), to estimate the motion of objects in a given 3D space, such as most real-world environments (e.g., yards, roads, atmosphere, oceans, outer space, and so forth). The systems and methods described herein improve over existing methods by offering accuracy at least 20% greater than other methods, while also being computationally faster and less intensive. One advantage of the approaches described herein is that, as non-learning, optimization-based approaches, the approaches may handle out-of-distribution data more readily and ably than learning-based approaches. For example, for learning-based approaches, since those approaches are trained on data and form a model based on that data, when exposed to data outside the training data, the learning approach may not behave predictably and/or may misbehave. In contrast, the optimization-based approaches described herein do not need training data and thus responds the same way to any input data.

To realize the greater accuracy and faster computational times mentioned above, a system that returns point-cloud data (hereafter referred to as a LIDAR system for simplicity, though the systems and methods described herein apply to any system that returns point-cloud data, such as RADAR, stereo-cameras, acoustic, ultrasonic, SONAR, and so forth) provides a sequence of point clouds over time. The motion of the sensor is accounted for between the points in the sequential point-clouds. Furthermore, points in sequential point-clouds are matched with one another (called correspondence matching) using an objective function that helps to determine the flow vector between corresponding points. The objective function may be refined using a local correlation weight matrix for the target point-cloud of the objective function. The local correlation weight matrix better aligns associated (that is, corresponding) points, thus producing more accurate results. Furthermore, to avoid false positives and other errors, an adaptive maximum correspondence threshold is applied to the point-clouds to eliminate correspondences between points that are too far apart, thus improving the quality of the estimates and/or improving the weight matrix. An intrinsic point-cloud matching transformation function is applied to the data to improve flow estimates, to increase convergence speed, and to distinguish static from dynamic points. The transformation function may be based on an iterative closest point (ICP) algorithm. A rigidity threshold may also be applied to associate locally proximate points of a point-cloud with one-another.

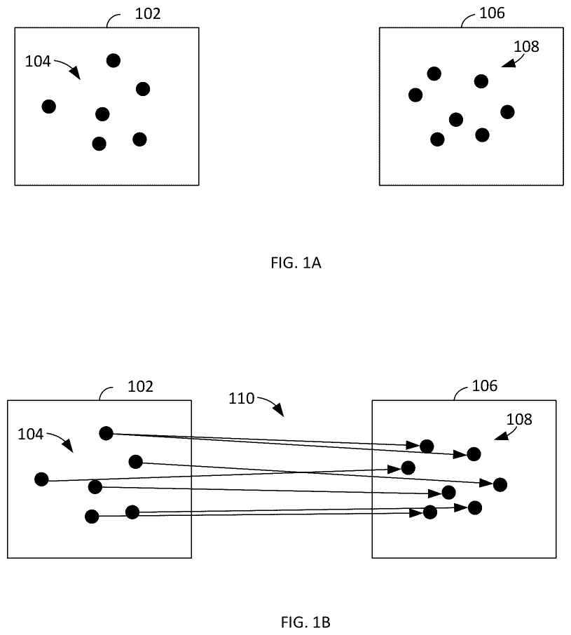

FIG. 1A illustrates a pair of point clouds according to an example. FIG. 1A includes a first point-cloud 102 and a second point cloud 106. The first point-cloud 102 contains a first group of one or more points 104 (“first group 104”). The second point-cloud contains a second group of one or more points 108 (“second group 108”).

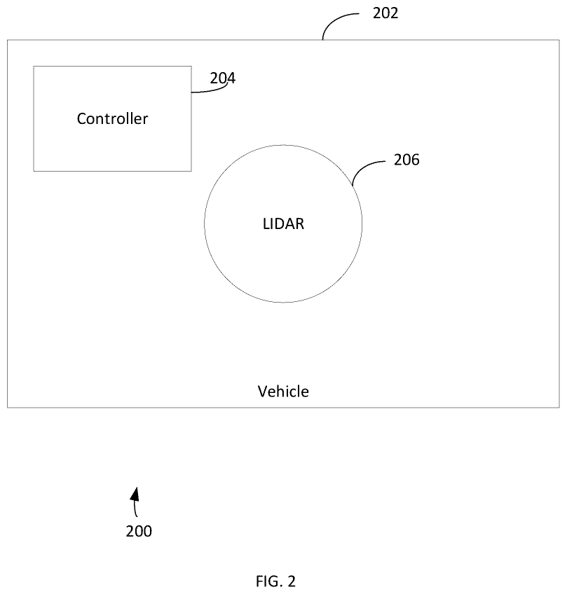

The first point-cloud 102 and second point-cloud 106 represent the values returned by a sensor system that returns data in a point-cloud format (e.g., LIDAR). In some examples, the point-clouds 102, 106 represent the same scene, possibly from different frames of reference and/or at different times. To understand how the scene has changed based on the point-cloud data, the points of the first group 104 and second group 108 may be associated with one another so that the sensor system understands that a particular point in the first group 104 corresponds to a particular point in the second group 108. In this way, the sensor system can understand the continuity between the points in each point-cloud, and thereby interpret the points to represent the scene correctly. Methods and systems used to acquire the point-cloud data and interpret it will be discussed in greater detail with respect to FIGS. 2-7.

The first point-cloud 102 is captured by a sensor system (e.g., by LIDAR) at a first point in time. The second point-cloud 106 is captured at a second point in time by the same or a similar sensor system. In this example, the second point-cloud 106 may be considered to have been captured after the first point-cloud 102. Both point-clouds represent the same scene (possibly from different physical positions relative to an outside frame of reference, such as the Earth).

The points contained within each point-cloud may be associated with certain characteristics. For example, in a LIDAR system, a laser is aimed at a target and the time between emitting light from the LIDAR, the light bouncing off the target, and the light returning to hit a sensor on the LIDAR system, may be measured. Thus, a LIDAR system may associate, with any given point, an orientation of the LIDAR at the time light was emitted from the LIDAR, and/or a time interval between emitting light and receiving light at the sensor. From this information, the position of surfaces which the emitted light bounced off, relative to the LIDAR system, may be determined using geometric relationships and the speed of the emitted light.

FIG. 1B is similar to FIG. 1A, but adds a plurality of flow vectors together indicated at 110 (“flow vectors 110”). Each flow vector of the plurality of flow vectors 110 represents a correspondence between one or more points of the first group 104 and one or more points of the second group 108. For example, the flow vectors 110 may represent a predicted motion (or flow) of the points of the first point-cloud 102 during the time between acquiring the first point-cloud 102 and the second point-cloud 106.

In some examples, points in the first point-cloud 102 or points in the second point-cloud 106 may not correspond to points in the other point-cloud or may correspond to more than one point in the other point-cloud. For example, at least one point of the first group 104 corresponds to more than one point of the second group 108 in the example illustrated in FIG. 1B.

The correspondence identified by the flow vectors 110 indicates whether a point of the first group 104 is related to and/or associated with a point of the second group 108. For example, corresponding points may be from light that bounced or reflected off the same object. The flow vectors 110 may be determined such that the distance between the points of the first group 104 and the points of the second group 108 are minimized for every point of the point-clouds 102, 106.

FIG. 2 illustrates a system 200 capable of associating point-clouds at different points in time. The system 200 includes an ego vehicle 202, at least one controller 204 (“controller 204”), and at least one sensor system 206 (“LIDAR 206”).

The ego vehicle 202 may be any type of vehicle. For example, the ego vehicle 202 may be a scooter, a robot, a bicycle, a car, a truck, a tractor, a drone, an airplane, a helicopter, and so forth. The ego vehicle 202 may be equipped with autonomous execution protocols allowing the ego vehicle 202 to operate autonomously (e.g., without a driver) or semi-autonomously.

The controller 204 may be any device or combination of devices capable of executing computer code and/or performing computations. The controller 204 may be coupled to the ego vehicle 202 and may be equipped with software and/or hardware that allows the controller 204 to operate the ego vehicle 202. The controller 204 may also be coupled to the LIDAR 206, and may be equipped to receive the data created by the LIDAR 206, such as the point-clouds generated by the LIDAR 206, and associate and/or determine correspondences between points in point-clouds generated by the LIDAR 206.

The LIDAR 206 may be a sensor system that returns data in a point-cloud format. The LIDAR 206 may include a single sensor or multiple sensors, and the sensors may be placed on one or more parts of the ego vehicle 202 (e.g., at the front and back, on top, below, on the sides, and so forth). In some examples, the LIDAR 206 is located on top of the ego vehicle 202.

The LIDAR 206 may take measurements at intervals or on-demand (e.g., at the request of the controller 204). When the LIDAR 206 takes measurements, it may emit an output, such as a light and/or sound, and measure the time between the emission of the output and the return of a reflection of the output (e.g., when the output bounces off an object in the scene). The LIDAR 206 may associate various data with the measurements, including the time between emission and return, the intensity of the output and reflection, and so forth. Some LIDAR 206 may be capable of returning doppler data related to the points between various point-clouds, however, the systems and methods described herein do not require doppler data and may function without the use of doppler data. Examples of point-cloud systems that return doppler data include FMCW LIDAR and many RADAR devices. In some examples herein, the LIDAR 206 may not be capable of returning or capturing doppler data.

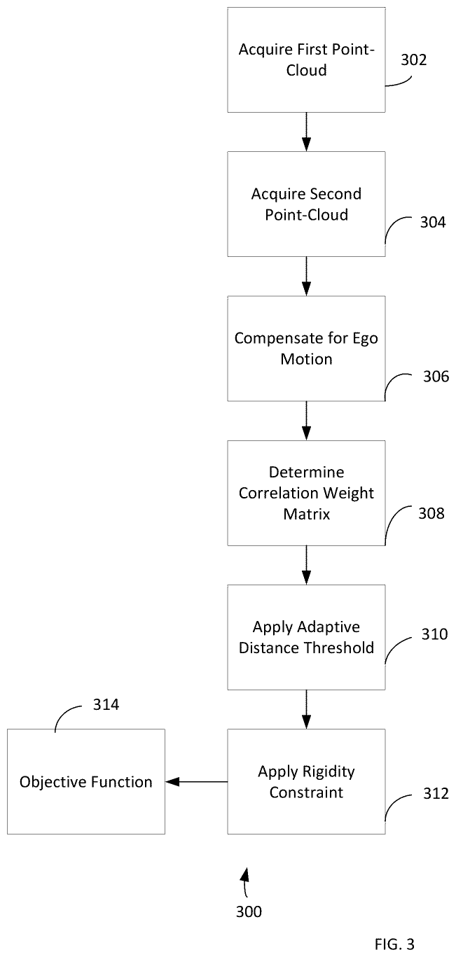

FIG. 3 illustrates a process 300 for determining the correspondence between points in two or more point-clouds. For the ease of discussion, the process 300 will refer to the controller 204 of FIG. 2 when discussing what performs the acts described below. However, any computational device, such as a processor, microprocessor, FPGA, ASIC, and so forth, may be used.

The process 300 describes determining a correspondence between the points of a target point-cloud and a reference point-cloud. The process 300 may be an unsupervised, non-learning process known as an optimization process or optimization method. With reference to the first point-cloud 102 and second point-cloud 106 of FIG. 1, either the first or the second point-cloud 102, 106 may be the reference point-cloud, and either may be the target point-cloud. However, only one may be the target point-cloud and only one may be the reference point-cloud at a time. For example, if the first point-cloud 102 is the reference point-cloud, the second point-cloud 106 may be target point-cloud. Likewise, if the second point-cloud 106 is the reference point-cloud, the first point-cloud 102 may be the target point-cloud.

To determine the correspondence between the target and reference point clouds, the reference and target point-clouds are acquired (e.g., by LIDAR 206). Then the motion of the ego vehicle is accounted for. A matrix of weights is applied to the points of the target and reference point-clouds to determine the correspondence between the points of those point-clouds. An adaptive distance threshold is applied as well, to eliminate points that are too far apart, and a rigidity constraint is applied to ensure that points are associated with the correct object and/or the correct group of other points.

At act 302, the LIDAR 206 acquires the reference point-cloud at a first point in time and provides the reference point-cloud to the controller 204. The process 300 may then continue to act 304.

At act 304, the LIDAR 206 acquires the target point-cloud at a second point in time, the second point in time being different from the first point in time. For example, the reference point-cloud may be acquired before the target point-cloud or after the target point-cloud (or simultaneously, if multiple sensors are in use). The LIDAR 206 provides the target point-cloud data to the controller 204. The process 300 may then continue to act 306.

At act 306, the controller 204 compensates for the motion of the ego vehicle 202 between the first time and the second time (that is, between when the target point-cloud and reference point-cloud were acquired). In examples where the first time and the second time are the same time, then the controller 204 may not need to compensate for the motion of the ego vehicle 202.

In some examples, the controller 204 may apply a transformation to every point in the target point-cloud and/or reference point-cloud. The transformation may be based on an Iterative Closest Point (“ICP”) based transformation function. The transformation may seek to match points in the point-clouds corresponding to moving objects, stationary objects, or both moving and stationary objects in the scene. The transformation may minimize the distance between the points of the point-clouds and/or account for the motion of the ego vehicle 202.

For example, the ego vehicle 202 may move during the time between acquiring the target and reference point-clouds, such that the ego vehicle 202 occupies a different position when acquiring the target point-cloud than the position the ego vehicle 202 occupied when acquiring the reference point-cloud. Because the ego vehicle 202 has moved, matching the points of the point-clouds may be more difficult without first transforming the point-clouds to reflect the motion of the ego vehicle 202. The transformation may involve rotation, translation, logarithmic transformations, reciprocal transformations, and so forth. The transformation may be multidimensional or may be unidimensional. The particular transformations applied may be based on the motion of the ego vehicle 202 and/or based on the point-clouds themselves (without reference to the motion of the ego vehicle 202). In some examples, the transformations may be limited to just rotation and/or translation.

The transformation may be found as part of the optimization process. As a result, the transformation to compensate for the motion of the ego vehicle 202 may be determined from the point-cloud data exclusively (e.g., from the first point-cloud 102 and the second point-cloud 106). In other examples, the transformation may be determined based on the motion of the ego vehicle 202 as communicated by the ego vehicle 202 or determined by other sensors.

In some examples, the transformation is applied to the points of the reference point-cloud. In some examples, the transformation is applied to the points of the target point-cloud. In some examples, the transformation is applied to the points of both point-clouds. In at least one embodiment of the methods and systems described herein, the transformation is applied to only the reference point-cloud.

Once the transformation is complete, the process 300 may continue to act 308.

At act 308, the controller 204 may apply a correlation weight matrix (“weight matrix”) to one or more of the point-clouds. The weight matrix may be based on k nearest points in the target point-cloud to a given point in the reference point-cloud and/or k nearest points in the reference point-cloud to a given point in the target point-cloud. In this context, “nearest” may refer to physical distance (after the transformation of act 306 is applied) as measured by the LIDAR 206.

Once the k nearest points are identified, the controller 204 may calculate a similarity metric between a reference point of the reference point-cloud and the k target points of the target point-cloud. The controller 204 may further determine a composite value based on all k similarity metrics determined for each of the k target points and the reference point. The resulting composite value may be used to modify and/or determine the correspondence between the reference point and the k target points. The controller 204 may, for every point in the reference point-cloud (that is, every reference point), determine k target points of the target point-cloud, the k target points being the k target points nearest that particular reference point. Thus, in some examples, for every point of the reference point-cloud there will be associated with those reference points k target points from the target point-cloud.

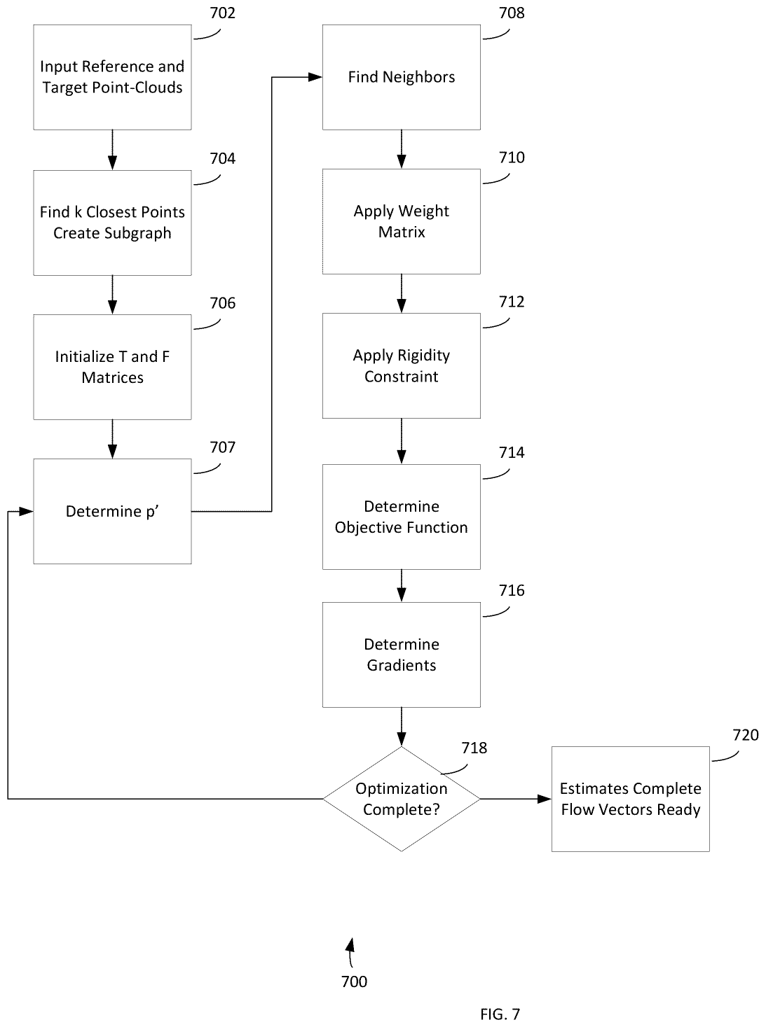

In some examples, the weight matrix may be calculated bidirectionally or independently for the points of the target point-cloud as well (that is, for every point of the target point-cloud, k nearest points of the reference point-cloud may be determined and the similarity metric and composite metric calculated). By applying the weight matrix bidirectionally in this manner, the point-clouds may be aligned with the principles of Chamfer distance, ensuring a more symmetrical and comprehensive evaluation of correspondences between the points of the point-clouds. Aspects of the bidirectional calculations will be discussed in greater detail below, including with respect to FIG. 7.

Once the weight matrix calculations are complete, the process 300 may continue to act 310.

At act 310, the controller 204 may determine the adaptive distance threshold (“ADT”). While constructing the weight matrix (of act 308), various points of the target point-cloud and reference point-cloud may be relatively distant from each other. For example, the nearest k points to a given point in the reference and/or target point-cloud may include some points that are more than a threshold distance (for example, 2 meters) distant from the given point. These relatively distant points that exceed the threshold distance may be outliers that represent noise, bad data, or simply false correspondences or associations. The controller 204 may therefore ignore these points or assign to them a set weight value (e.g., a value of zero) in the weight matrix. Thus, only those points of the k points that are within the threshold distance will contribute to the flow determination (e.g., for the final flow field).

As mentioned, the ADT is adaptive, meaning that the threshold distance can change over time. In some examples, the threshold distance may be decreased by a set or variable amount. Decreasing the threshold distance may occur at regular or irregular intervals. For example, for every n samples taken by the LIDAR 206, the threshold distance may be halved (or decreased by a set amount). In some examples, n may be set to 100, less than 100, or more than 100. In some examples, n samples corresponds to n measurements by the LIDAR 206 (which may correspond to n point-clouds being generated by the LIDAR 206 and returned to the controller 204). In some examples, the n samples may correspond to something else, such as a number of iterations (as further discussed below).

The threshold distance may have a maximum value that it cannot exceed and a minimum value that it cannot fall below. The threshold distance may initialized to a value that is preset (e.g., determined by a user or determined by the controller 204), or the controller 204 may initialize the threshold distance based on the point-clouds or other factors. Similarly, the maximum and minimum distance may be preset or determined based on the point-clouds or other factors. For example, the maximum distance, minimum distance, and threshold distance may be based on part on the speed of the ego vehicle 202 and/or the sample rate of the LIDAR 206.

Once the weight matrix has been modified via application of the ADT, the process 300 may continue to act 312.

At act 312, the controller 204 may apply a rigidity constraint to maintain geometric coherence in the reference and/or target point-cloud. The rigidity constraint applies to a subgroup of points in the point-cloud, essentially treating those points as part of the same object and seeking to generate flows between the reference point-cloud and target point-cloud that reflect the characteristic motion of rigid bodies in the scene.

For example, suppose a car is driving through a scene. It may be expected that the car behaves like a rigid body because the parts of cars are generally coupled together in a rigid manner that causes all parts to move together as the car moves. Therefore, the rigidity constraint operates to treat locally related points as part of the same rigid body. Locally related points may be points that are nearby one another (e.g., in terms of physical distance). Note that the rigidity constraint applies to semi-static objects as well, including those with moving parts that move with the unit (e.g., the flapping wings of birds, helicopter blades, legs, and so forth, all of which are permanently coupled to other objects, but have a range of motion of their own) and may be used to associate elements that move together but are not completely static with respect to one another.

The rigidity constraint may seek to minimize a difference between flow vectors for points within the local region (e.g., within the relevant group of points). Local regions may overlap with one another.

The process 300 may then continue to act 314.

At act 314, the various matrices, transformations, and other constraints applied in the foregoing acts combine to produce an objective function. The controller 204 may evaluate the objective function to determine the flow vectors associated with the points in the reference and target point-clouds. The flow vectors may then be used to estimate the motion of objects in the scene, and for any other purpose desired.

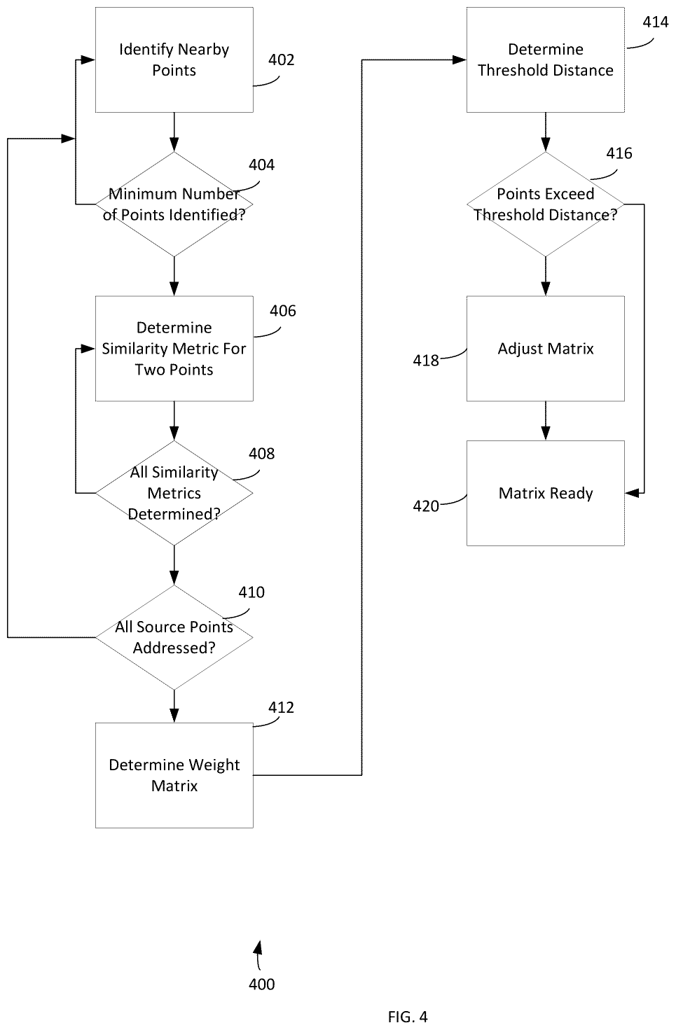

FIG. 4 illustrates a process 400 for determining the weight matrix. The process 400 may be one example of acts 308 and 310 of FIG. 3. Alternatively, the process 400 may be combined with or incorporated into process 300 of FIG. 3.

The discussion of process 400 refers to a source point-cloud and a comparison point-cloud. The source point-cloud may be a reference point-cloud or a target point-cloud. Likewise, the comparison point-cloud may be a reference point-cloud or a target point-cloud. However, in general, the source point-cloud and the comparison point-cloud will not be the same point-cloud. Points of the source point-cloud will be referred to as “source points,” and points of the comparison point-cloud will be referred to as “comparison points.”

At act 402, the controller 204 identifies numerous points of the comparison point-cloud that are nearby a source point of the source point-cloud. In some examples, the controller 204 may identify up to k comparison points that are nearby the source point. The controller 204 may determine that comparison points are nearby the source point by using a distance (e.g., physical distance) or similarity metric. Once the controller 204 has identified one or more comparison points, the process 400 may then continue to act 404.

At act 404, the controller 204 determines whether k comparison points have been identified. In some examples, k may be 50, less than 50, or greater than 50. If k comparison points have not been identified, the process 400 may return to act 402 to identify additional comparison points. If k nearby points have been identified, the process 400 may continue to act 406.

At act 406, the controller 204 may determine the similarity between one of the k comparison points and the source point. The controller 204 may determine the similarity between the source point and a given comparison using a similarity metric. In some examples, the similarity metric between the source point and the comparison point of the k comparison points may be calculated according to or based on the equation:

$$S = {e}^{- {d}^{2}} \qquad ( 1 )$$

where S is the similarity, e is the base of the natural logarithm and d is the distance between the reference point and the selected point of the k points. The process 400 may then continue to act 408.

At act 408, the controller 204 determines whether a respective similarity has been determined for the source point and each of the respective k comparison points. If the similarity for the source point and a respective comparison point of the k points has not been determined, the process 400 may return to act 406 and determine the similarity between the source point and the comparison point (or points) of the k points for which the similarity has not previously been determined. If the similarity for every pair of the source point and comparison point of the k points has been determined, the process 400 may continue to act 410.

When the process 400 continues to act 410, it will be noted that there may be k similarity metrics determined, one for each combination of the source point and a point of the k comparison points. Thus, if the source point is given the index 1, and the comparison points are given indices of 1 through k, there will be a similarity metric and/or similarity determined for (1,1), (1,2), . . . (1, k), where (i, j) represents a given source point, i, and a given comparison point associated with that specific source point, j.

At act 410, the controller 204 determines whether every source point of the source point-cloud has been associated with k nearby comparison points and whether similarity has been calculated for each source point of the source point-cloud and k respective comparison point of the comparison point cloud. If the controller 204 determines that one or more source points have not been associated with k similarity metrics, the process 400 may return to act 402 and identify new comparison points for a new source point, the new source point being a source point that has not previously been associated with k comparison points and/or k similarity metrics. If every source point has been associated with k comparison points and/or k similarity metrics, the process 400 may then continue to act 412.

If every source point has been associated with k comparison points, there will be n·k total similarities determined, where n is the number of source points considered (which may be equal to the number of points in the source point-cloud). Using the (i, j) notation above, there will be similarity metrics for (1,1), . . . , (1, k), (2, 1), . . . , (2, k), . . . , (n, 1), . . . , (n, k). Note that the k points associated with a given source point may be different from the k points associated with a different source point.

At act 412, the controller 412 determines the weight matrix. The weight matrix may be determined for every source point and comparison point (i, j) from (1,1) through (n,k). The value of the weight matrix corresponding to a given comparison and source point pair may be determined based on the similarity and/or similarity metric for that pair. For example, the controller 412 may use the equations:

$${M}_{i j} = exp ( \frac{{S}_{i j} - 1}{ϵ} ) \qquad ( 2 )$$

where Mᵢⱼ refers to the value of the weight matrix, M, at a given index (i,j), exp is the exponential function that calculates ex where x is the argument of the function, Si is the similarity determined for a given source-point-comparison-point pair (i,j), and epsilon (ε) is predetermined value that may be fixed (i.e., constant). In some examples, epsilon may be greater than 0 and less than 1, in other examples epsilon may be less than 0 or greater than 0. Once the weight matrix is determined, the process may continue to act 414.

At act 414, the controller 204 determines the threshold distance (e.g., the ADT of act 310 of FIG. 3). The controller 204 may determine the threshold distance based on a maximum and minimum threshold distance, a number of iterations, and so forth. Once the controller 204 determines the threshold distance, the process 400 may then continue to act 416.

At act 416, the controller 204 determines which pairs (if any) of source point and corresponding comparison point exceed the threshold distance. For example, the controller 204 may determine that a given point of the k comparison points associated with a given source point was located more than the threshold distance away from the source point. The process 400 may then proceed to act 418. If the controller 204 determines that no pairs of source point and respective comparison point exceeded the threshold distance, the process 400 may proceed to act 420.

At act 418, the controller 204 may take each source-point-comparison-point pair for which the pair exceeded the threshold distance and adjust the weight (e.g., the value assigned to that pair in the weight matrix, M). In some examples, the controller 204 may reduce the weight associated with the pair. In some examples, the controller 204 may set the weight associated with the pair to zero. The process 400 may then continue to act 420.

At act 420, the controller 204 may use the weight matrix for any purpose. In some examples, the controller 204 may use the weight matrix to calculate the composite value for one or more source points and/or use the composite value of one or more source points to modify an objective function. The composite value may be determined based on or using the equation:

$${q}_{i} = \frac{{Σ}_{j = 1}^{k} {M}_{i j} \cdot {q}_{j}}{{Σ}_{j = 1}^{k} {M}_{i j}} \qquad ( 3 )$$

where Mᵢⱼ·qⱼ is the product between the value of the weight matrix, M, at (i,j), and the j^{th} comparison point of the nearest k comparison points corresponding to the given source point, qⱼ. In some examples, a correspondence matrix, Qᵢ, may be used to contain all composite values corresponding to all points in the reference point-cloud (that is, to contain all qᵢ). In some examples, the composite value may be a weighted average of all k comparison points.

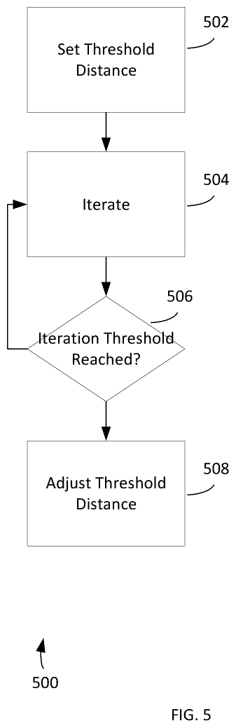

FIG. 5 illustrates a process 500 for adjusting the threshold distance (for example, the threshold distance of act 310 of FIG. 3).

At act 502, the controller 204 determines the threshold distance. The controller 204 may determine the threshold distance by, for example, setting the threshold distance to a maximum or minimum value, using a previously determined threshold distance, and so forth.

To determine the threshold distance, the controller 204 may use the improvements in correspondence between estimates of points in the source point-cloud and comparison point-cloud. In some examples, the controller 204 may use an average improvement in the correspondence. Based on the improvements in correspondence, the controller 204 may adjust the threshold distance proportionally to the changes in correspondence. The process 500 may then continue to act 504

At act 504, the controller 204 executes an iteration. Iterations may be measured in various ways. In some examples, a single iteration may be a single calculation of the flow vectors between two point-clouds. In some examples, the controller 204 may repeatedly calculate flow vectors (or repeatedly refine the objective function, for example by repeating the process 300 of FIG. 3 more than once with the same two point-clouds before calculating the flow vectors), such that each repetition is an iteration. In some examples, the controller 204 may refine the objective function and/or calculate the flow vectors in a bidirectional manner, in which examples a single iteration may be equivalent to determining the objective function and/or flow vectors with respect to the target point-cloud and reference point-cloud and reference point-cloud and target point-cloud. In some examples, each time the LIDAR 206 takes a measurement to return a new point-cloud and the controller 204 calculates the flow vectors between the new point-cloud and a preceding point-cloud may count as an iteration. Once the controller 204 has executed an iteration, the process 500 may continue to act 506.

At act 506, the controller 204 determines whether a threshold number of iterations (“iteration threshold”) has occurred since the controller 204 last determined the threshold distance. For example, if the controller 204 has an iteration threshold of 50 and the controller 204 last determined the threshold distance 25 iterations ago, then the controller 204 may determine that the iteration threshold has not been reached. Likewise, if the controller 204 has an iteration threshold of 50 and 50 iterations have occurred since the controller 204 last determined the threshold distance, then the controller 204 may determine that the iteration threshold has been reached. In some examples, if the number of iterations equals and/or exceeds the iteration threshold, the controller 204 may determine that the iteration threshold has been reached. Once the controller 204 determines the iteration threshold has been reached, the process 500 may continue to act 508. If the controller 204 determines that the iteration threshold has not been reached, the process 500 may return to act 504 and perform another iteration.

The number of iterations may be any integer number equal to or greater than 0, for example, 0, 1, 10, 50, 100, 500, 10,000, and so forth.

At act 508, the controller 204 adjusts the distance threshold. The controller 204 may increase or decrease the distance threshold by a predetermined amount or by a predetermined factor. For example, the controller 204 may reduce the threshold by a set amount of distance (but not below any minimum value required) or may increase the threshold by a set amount of distance (but not above any maximum value required). Likewise, the controller 204 may multiply and/or divide the threshold distance by a predetermined value, although the controller 204 may not reduce the threshold distance below the minimum value or raise it above the maximum value. If the threshold distance exceeds the maximum value or falls below the minimum value, the controller 204 may instead set the threshold distance to the maximum value and/or minimum value. In some examples, the controller 204 may reduce the threshold distance by half (e.g., multiply the threshold distance by a factor of 0.5).

In some examples, the threshold distance, the minimum distance, and/or the maximum distance may be adjusted based on the distance between points in the point-cloud. For example, when objects are closer to the LIDAR 206, the point-cloud generated by the LIDAR 206 will generally be denser than the point-cloud generated when an object is far away. Thus, the density of the point-cloud may be used to determine what threshold distance and/or range of distances should be used.

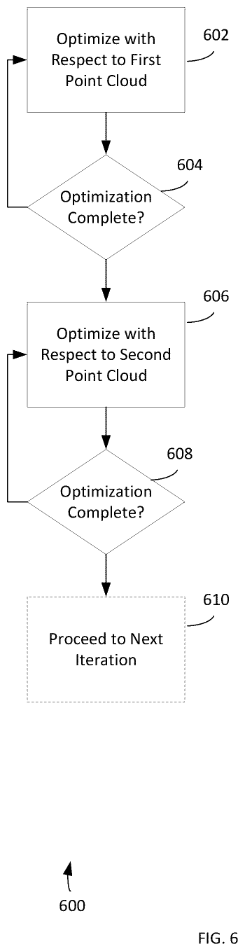

FIG. 6 illustrates a process 600 for bidirectional optimization according to an example. The process 600 illustrates how the optimization process (e.g., the process 300 of FIG. 3) may be applied in a bidirectional manner.

At act 602, the controller 204 optimizes the objective function with respect to the first point-cloud 102. The controller 204 may optimize the objective function using the process 300 of FIG. 3. The first point-cloud 102 may be considered the reference point-cloud in this context, and the second point-cloud 106 may be considered the target point-cloud in this context. The process 600 may then continue to act 604.

At act 604, the controller 204 verifies that the optimization of act 602 is complete. If the controller 204 determines that the optimization of act 602 is complete, the process 600 may continue to act 606. If the controller 204 determines that the optimization of act 602 is not complete, the process 600 may return to act 602 to complete the optimization of act 602.

At act 606, the controller 204 optimizes the objective function with respect to the second point-cloud 106. The controller 204 may optimize the objective function using the process 300 of FIG. 3. The first point-cloud 102 may be considered the target point-cloud in this context, and the second point-cloud 106 may be considered the reference point-cloud in this context. The process 600 may then continue to act 604. In some examples, this “backward” pass may bring the distance considered by the controller 204 into line with the principles of Chamfer distance.

At act 608, the controller 204 verifies that the optimization of act 606 is complete. If the controller 204 determines that the optimization of act 606 is complete, the process 600 may continue to act 610. If the controller 204 determines that the optimization of act 606 is not complete, the process 600 may return to act 606 to complete the optimization of act 606.

At optional act 610, the process 600 may proceed to a next iteration. The next iteration may involve the same point-clouds as the previous iteration. An iteration may include making or refining at least one estimate of at least one flow vector.

FIG. 7 illustrates a process 700 for optimizing an objective function using two point-clouds according to an example, including a reference point-cloud and a target point-cloud. The process 700 may, in some examples, be a version of the process 300 of FIG. 3.

In some examples, the purpose of process 700 is to minimize the distance between the points of the target point-cloud and the points of the reference point-cloud once the flow vectors have been accounted for. This objective may be expressed in the form of an objective function:

$${F}^{*} = arg min \sum dist ( {p}_{i} + {f}_{i} , {P}_{t} ) \qquad ( 4 )$$

where arg min indicates that the goal is to minimize F*, dist is a distance function indicating the distance between a pᵢ+fᵢ and Pₜ, where Pₜ is the nearest point in the target point-cloud to the point pᵢ+fᵢ in the reference point-cloud, pᵢ is a point in the reference point-cloud, and fᵢ is an expected flow of pᵢ (that is, an expected change in the position of pᵢ). Put another way, pᵢ+fᵢ represents the expected position of pᵢ when the target point-cloud is acquired, and Pₜ represents the position of p; when the second point-cloud is acquired.

At act 702, the controller 204 receives and/or initializes the target point-cloud and the reference point-cloud. The reference point-cloud may be a point-cloud of the scene at an earlier time than the target point-cloud. The controller 204 may then proceed to act 704.

At act 704, the controller 204 determines the k closest points in the reference point-cloud for each other point in the reference point-cloud. The controller 204 may create a subgraph, G, of the k closest points in the reference point-cloud for each point in the reference point-cloud. The process 700 may then continue to act 706.

At act 706, the controller 204 initializes and/or determines the transformation matrix, T, and a flow matrix, F. The transformation matrix may be a matrix configured to compensate for the motion of the ego vehicle 202 (e.g., as described with respect to act 306 of FIG. 3). The flow matrix may be a matrix to contain flow vector values. The transformation matrix and/or flow matrix may be initialized as null matrices. The process 700 may then continue to act 707.

At act 707, the controller 204 determines a point matrix for the reference point-cloud. The controller 204 may determine and apply the transformation matrix, T, to points in the reference point-cloud as part of determining the point matrix. The controller 204 may determine and apply the flow matrix to the reference point-cloud as well. In iterations after the first, the transformation matrix and/or flow matrix may be refined or improved to reflect better estimates and more accurate or correct values. The point matrix may be expressed as:

$${P}^{′} = {TP}_{R} + F \qquad ( 5 )$$

wherein Tis the transformation matrix, PR is a matrix of all points in the reference point-cloud, and F is a matrix of all flow vectors corresponding to all points in the reference point-cloud. In some examples, the controller 204 will refine P′ based on feedback from the optimization process.

The process 700 may then continue to act 708.

At act 708, the controller 204 determines k nearest neighbors in a forward pass and/or a backward pass. In the forward pass, the controller 204 determines the k nearest neighbors in the target point-cloud (e.g., nearest points) to each of the points in P′. The controller 204 may also create a graph, G_{f}, containing the k nearest neighbors in the target point-cloud to each of the points in P′. In the backward pass, the controller 204 determines the k nearest neighbors in P′ to each of the points in the target point-cloud. The controller 204 may also create a graph, G_{b}, containing the k nearest neighbors in P′ to each of the points in the target point-cloud.

The process 700 may then continue to act 710.

At act 710, the controller 204 may apply one or more weight matrices (e.g., the weight matrix of act 308 of FIG. 3) to the graphs G_{f} and/or G_{b}. Each of G_{f} and/or G_{b} may have their own corresponding weight matrix (rather than the same weight matrix being used for both). The weight matrix and associated composite values may be determined, for example, using equations (1), (2), and/or (3), as described with respect to FIG. 4. The weight matrix may be determined according to, for example, the process 400 of FIG. 4. In some examples, the weight matrix may be generated according to equation (2). The composite values associated with the weight matrix may then be determined as a weighted average of the values of the weight matrix. For example, the composite values may be determined according to equation (3). The controller 204 may adjust the objective function based on the composite values. For example, with respect to the forward pass, the loss function, Lⱼᵢ, may be expressed as:

$${L}_{1} = {\sum }_{i = 1}^{n} \vert \vert {Tp}_{i} + {f}_{i} - {q}_{i} {\vert \vert}_{2}^{2} \qquad ( 6 )$$

where qᵢ is the composite value associated with a particular point, pᵢ, of the reference point-cloud, and qᵢ may be an element of the correspondence matrix Qᵢ. The equation (6) may be applied in a backward pass as well (e.g., using pₜ, fₜ, and qₜ corresponding to the target matrix). In some examples, equation (6) applied in both forward and backward pass is equivalent to the following expression in matrix notation:

$${L}_{1} = \vert \vert {P}^{′} - {Q}_{f} {\vert \vert}_{2}^{2} + \vert \vert {P}_{T} - {Q}_{b} {\vert \vert}_{2}^{2} \qquad ( 7 )$$

where L₁ is a measure of loss, which may be considered a measurement of error, and P_{T} is a matrix of the points in the target point-cloud. Q_{f} and Q_{b} are correspondence matrices corresponding to P′ and P_{T}, respectively. The loss may be based on weights and/or composite values (including those generated in forward and backward passes), and/or the points of P′ and/or the target point-cloud.

As mentioned, L₁ may be applied in a backward and forward pass, such that G_{f} is adjusted based on a matrix Q_{f} and G_{b} is adjusted based on a matrix Q_{b}, where Q_{f} corresponds to the weights of the k nearest neighbors in the target point-cloud to each of the points in P′, and Q_{b} corresponds to the weights of the k nearest neighbors in P′ to each of the points in the target point-cloud.

The process 700 may then continue to act 712.

At act 712, the controller 204 may apply a rigidity constraint to subgraph G and minimize the flow difference between the points in the reference point-cloud. In some examples, the controller 204 may apply the rigidity constraint and minimize flow difference using the relationship:

$${L}_{2} = \sum {W}_{ij} \vert \vert {f}_{i} - {f}_{j} {\vert \vert}_{2}^{2} \qquad ( 8 )$$

$${W}_{i j} = {e}^{- {d}_{i j}^{2}} \qquad ( 9 )$$

where Wᵢⱼ is a weight similar to S, corresponding to a pair of points, (i,j), where i is a point in the reference point-cloud and j is a point in the target point-cloud, −d is a distance between the points i and j, fᵢ is a flow for a point, i, and fⱼ is a flow vector for a point, j.

The process 700 may then continue to act 714.

At act 714, the controller 204 determines and/or updates the objective function. As mentioned above, the objective function was expressed by equation (4). However, at this point the transformation matrix has also been applied. As a result, the objective function may be expressed as:

$${F}^{*} = arg min \sum dist ( {Tp}_{i} + {f}_{i} , {P}_{t} ) \qquad ( 10 )$$

where T is the transformation matrix. In some examples, the controller 204 may base the objective function on previously determined values of fᵢ, for example, as the function is refined over numerous iterations (as will be described with respect to act 718). The updated objective function and values associated with it (e.g., T and F) may be used in future iterations to initialize the matrices and/or refine the values contained in the matrices (e.g., the matrices T and F).

The process 700 may then continue to act 716.

At act 716, the controller 204 determines one or more gradients and updates the flow and transformation matrices (e.g., the F and T matrices). The controller 204 may determine the gradients and updates the flow and transformation matrices based the loss and rigidity constraint (e.g., based on L₁ and L₂). In some examples, the gradient may be determined based on the matrix, L, where:

$$L = {L}_{1} + α {L}_{2} \qquad ( 11 )$$

thus equation (11) may be rewritten in the form:

$$L = {Σ}_{i = 1}^{n} \vert \vert {Tp}_{i} + {f}_{i} - {q}_{i} {\vert \vert}_{2}^{2} + α {Σ}_{i , j} {W}_{ij} \vert \vert {f}_{i} - {f}_{j} {\vert \vert}_{2}^{2} \qquad ( 12 )$$

where alpha is a predetermined value and may be constant. In some examples, alpha is determined using a hyperparameter search function. The process 700 may then continue to act 718.

At act 718, the controller 204 determines whether optimization is complete. If the controller 204 determines that optimization is complete, the process 700 may continue to act 720. If the controller 204 determines that optimization is not complete, the process 700 may return to act 707 and determine a new objective function, F*, and/or new point matrix, P′, based on the adjustments made during the intervening acts 710 through 716.

The controller 204 may determine whether optimization is complete based on an iteration threshold. An iteration may be equivalent to performing the actions described in acts 708 through 716 each at least once. Thus, a single iteration may reflect the performance of acts 708 through 716 once each. The iteration threshold may reflect a minimum number of iterations that must be performed prior to moving on to act 720. Thus, the controller 204 may determine that acts 708 through 716 have not been performed at least the iteration threshold number of times, and thus may return to act 708, or may determine that the acts 708 through 716 have been performed at least the iteration threshold number of times, and may proceed to act 720.

The iteration threshold may be arbitrary, and may be greater than or equal to zero. In some examples, the iteration threshold may be 10, 25, 100, 250, 500, 1000, or any other positive number. The iteration threshold may also be adjusted over time.

At act 720, the controller 204 may use the objective function and/or point matrix F* and/or point matrix P′ for any purpose.

In the foregoing discussion, although doppler and reflectance data is not necessary for the systems and methods disclosed herein to function, doppler data and/or reflectance data may nonetheless be used. For example, said data may be added to the calculation of similarity by changing the distance from a physical distance to a vector containing distance, reflectance, and so forth. Then, based on each element of the vector, the Euclidean distance may be calculated. In some examples, the extra dimensions may be weighted by a factor so that the impact, on similarity, can be tuned for each element of the distance vector. In some examples, the rigidity constraint may be modified based on the doppler and/or reflectance data by, for example, requiring that related or nearby points have similar velocities.

In the foregoing examples, the controller 204 may use multiple frames to find correspondence and to estimate flow simultaneously or sequentially. For example, the controller 204 may acquire several sequential point-clouds, some of which may be used as target point-clouds for earlier point-clouds, and as reference point-clouds for later point-clouds. For example, if acquiring three sequential point-clouds, the first may be a reference point-cloud and the second a target point-cloud in one frame, and for another frame the second may be used as a reference point-cloud and the third as a target point-cloud, and so forth. When processing these frames in parallel, the optimization and/or scene flow estimation may be performed simultaneously with respect to one or more pairs of point-clouds, and the results used to propagate flows between non-sequential point-clouds. For example, with respect to the three point-clouds referenced above, optimization and/or flow estimation may be performed simultaneously with respect to the first and second point-clouds and the second and third point-clouds, and then the flows from the first point-cloud may be propagated to the third point-cloud.

In some examples, frames may be used in a staggered manner (e.g., a semi-parallel manner). In these examples, the optimization and/or flow estimation may be carried out such that the results from an earlier optimization and/or estimation are used to initialize values in a later estimation and/or optimization. For example, with reference to the three point-clouds referred to above, it is possible to find flow vectors based on the first and second point cloud while optimizing for the second and third point-cloud combination. Then, when it is time to initialize the transformation and flow matrices for the second and third point-cloud combination, those matrices may be populated with values calculated and/or determined during the first and second point-cloud optimization and flow estimation process. This approach can lead to much faster convergence and may allow the methods and systems described herein to be executed at speeds suitable for real-time use.

The techniques described herein may also be used with two-dimensional data by applying depth estimates to the two-dimensional data. One technique of depth estimation that may be used is monocular depth estimation.

In the foregoing examples, a subset of the target and reference and/or comparison and source and/or first and second point-clouds may be used. For example, instead of using all points of the source point-cloud or reference point-cloud, a random selection of points of the source point-cloud and/or reference point-cloud may be used instead. The points may be randomly selected for every iteration if desired. Furthermore, other selection methods may also be used. For example, selecting based on proximity to the sensor, or selecting based on a region-of-interest near the ego vehicle or in the scene, and so forth.

In the foregoing examples, and throughout this disclosure, the techniques described herein may also be applied to other applications. For example, robotics navigation and path planning, augmented reality and virtual reality point flow estimation and optimization, motion detection, crowd management (to, for example, model the motion of people in space), transportation and traffic management, and so forth. In general, the techniques described herein may be used anywhere where there is a need or desire to estimate the motion of objects in 3D space.

Examples of processes contained herein need not be executed in the order provided. The order provided is only one example, and other orders may also be used. For example, in process 300 of FIG. 3, the adaptive distance threshold (act 310) could be applied earlier than determining the weight matrix (act 308), such that the weight matrix depended on or was based on only points that were within the threshold distance. Likewise, acts may be performed in parallel or overlapping manner rather than in sequence.

The techniques described herein may also be used when the point-clouds are taken at the same time. For example, for a first point-cloud and a second point-cloud taken by two LIDARs that share at least a portion of a field of view, the techniques described herein may be used to calibrate those LIDARs to one another such that the changes in the reference frame between the two LIDARs (e.g., the rotation, translation, and other transformations) between the two LIDARs may be determined.

With respect to the matrices herein, including the flow matrix and transformation matrix, the values of these matrices may be determined from only the point-clouds and/or may be determined using other sensor data. For example, the transformation and/or flow matrices could be initialized using data from sensors monitoring the motion of the ego vehicle (e.g., ego vehicle 202 of FIG. 2).

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 204, may execute various operations discussed above. Using data stored in associated memory and/or storage, the controller 204 also executes one or more instructions stored on one or more non-transitory computer-readable media, which the controller 204 may include and/or be coupled to, that may result in manipulated data. In some examples, the controller 204 may include one or more processors or other types of controllers. In one example, the controller 204 is or includes at least one processor. In another example, the controller 204 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1-13. (canceled)

14. A system for unsupervised estimation of motion of objects through a 3D space comprising:
a physical sensor located within the 3D space and configured to generate a plurality of point clouds; and
a controller configured to determine a correspondence between at least a first point in a first point cloud of the plurality of point clouds and a composite value,
wherein points in the plurality of point clouds obtained from the sensor provide distance information about the points relative to the location of the sensor in the 3D space,
wherein the composite value is a function of a plurality of points in a second point cloud of the plurality of point clouds,
wherein the correspondence is represented as a flow vector directed from the first point in the first point cloud to a location within the second point cloud corresponding to the composite value, and
wherein the composite value weighs certain of the plurality of points of the second point cloud relatively more than other points of the plurality of points of the second point cloud.

15. The system of claim 14 wherein the sensor is moveable within the 3D space.

16. The system of claim 15 further comprising a vehicle, wherein the sensor is coupled to the vehicle, wherein the vehicle is configured to autonomously navigate within the 3D space.

17. The system of claim 14 wherein the controller determines the correspondence using an objective function based on a distance measured between points in the first point cloud and corresponding composite values in the second point cloud.

18. The system of claim 15 wherein the controller determines the correspondence and an estimate of motion of the sensor from a location where the first point cloud is obtained to a location where the second point cloud is obtained,
wherein the determining of the correspondence and the motion estimate uses an objective function based on a distance measure between points in the first point cloud and corresponding composite values in the second point cloud, and
wherein the distance measure compensates for the motion.

19. The system of claim 17 wherein the controller determines distances from the first point in the first point cloud to each point of a plurality of points in the second point cloud,
wherein the controller compares the determined distances to a distance threshold, and
wherein the controller uses points whose determined distance is less than the distance threshold in the determining of the composite value.

20. The system of claim 19 wherein the controller determines the correspondence iteratively, and
wherein the distance threshold has an initial value for a first iteration and the controller updates the distance threshold value in subsequent iterations of the determining of the correspondence.

21. The system of claim 14 wherein the controller determines the flow vectors in a bi-directional manner.

22. The system of claim 17 wherein the controller determines the objective function in a bi-directional manner.

23. The system of claim 17 wherein the objective function incorporates a rigidity constraint.

24. A method for unsupervised estimation of motion of objects through a 3D space comprising:
generating a plurality of point clouds with a physical sensor located within the 3D space, wherein points in the plurality of point clouds obtained from the sensor provide distance information about the points relative to the location of the sensor in the 3D space;
determining by the controller a composite value, wherein the composite value is a function of a plurality of points in a second point cloud of the plurality of point clouds;
determining by a controller a correspondence between at least a first point in a first point cloud of the plurality of point clouds and the composite value,
wherein certain of the plurality of points of the second point cloud are weighed relatively more than other points of the plurality of points of the second point cloud when the composite value is determined; and
representing the correspondence as a flow vector directed from at least the first point in the first point cloud to a location within the second point cloud corresponding to the composite value.

25. The method of claim 24 further comprising moving the sensor within the 3D space.

26. The method of claim 25 further comprising autonomously navigating a vehicle within the 3D space, wherein the sensor is coupled to the vehicle.

27. The method of claim 24 further comprising determining, by the controller, the correspondence,
wherein the correspondence is determined using an objective function based on a distance measure between points in the first point cloud and corresponding composite values in the second point cloud.

28. The method of claim 25 further comprising determining, by the controller, the correspondence and an estimate of motion of the sensor from a location where the first point cloud is obtained to a location where the second point cloud is obtained,
wherein determining the correspondence and the estimate of motion uses an objective function based on a distance measure between points in the first point cloud and corresponding composite values in the second point cloud,
wherein the distance measure compensates for the motion.

29. The method of claim 27 further comprising determining, by the controller, distances from the first point in the first point cloud to each point of a plurality of points in the second point cloud,
comparing, by the controller, the determined distances to a distance threshold, and
selecting, by the controller, points to use for the determining of the composite value, wherein selected points have determined distances that are less than the distance threshold.

30. The method of claim 29 wherein the determining of the correspondence by the controller is performed iteratively, wherein the distance threshold has an initial value for a first iteration, and
updating, by the controller, the distance threshold value for subsequent iterations of the determining of the correspondence.

31. The method of claim 24 wherein the determining of the flow vectors by the controller is done in a bi-directional manner.

32. The method of claim 27 wherein the determining, by the controller, of the objective function is done in a bi-directional manner.

33. The method of claim 27 wherein the determining of the correspondence by the controller uses an objective function in which a rigidity constraint has been incorporated.

34. A non-transitory computer-readable medium storing thereon sequences of computer-executable instructions for unsupervised estimation of motion of objects through a 3D space, the sequences of computer-executable instructions including instructions that instruct at least one processor to:
generate a plurality of point clouds with a physical sensor located within the 3D space, wherein points in the plurality of point clouds obtained from the sensor provide distance information about the points relative to the location of the sensor in the 3D space;
determine by the controller a composite value, wherein the composite value is a function of a plurality of points in a second point cloud of the plurality of point clouds;
determine by a controller a correspondence between at least a first point in a first point cloud of the plurality of point clouds and the composite value,
wherein certain of the plurality of points of the second point cloud are weighed relatively more than other points of the plurality of points of the second point cloud when the composite value is determined; and
represent the correspondence as a flow vector directed from at least the first point in the first point cloud to a location within the second point cloud corresponding to the composite value.
